(19) United States
(12) Patent Application Publication
(10) Pub. No.: US 2005/0259038 A1
(43) Pub. Date: Nov. 24, 2005

(54) Display device

(75) Inventors: Akira Otsuka, Kawasaki (JP); Takashi Sasaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Kawasaki (JP)

(21) Appl. No.: 11/126,179

(22) Filed: May 11, 2005

(30) Foreign Application Priority Data
May 21, 2004 (JP) 2004-152560

(51) Int. Cl. G09G 3/28

(52) U.S. Cl. 345/60

(57) ABSTRACT

The present invention provides a display device including: a plurality of X electrodes and a plurality of Y electrodes, with capacitances of display cells being formed therebetween; a first X-electrode current path through which an electric current flows to/from the odd-numbered X electrodes; a second X-electrode current path through which an electric current flows from/to the even-numbered X electrodes synchronously with and in a reverse direction to the flow of the electric current to/from the odd-numbered X electrodes through the first X-electrode current path; a first Y-electrode current path through which an electric current flows to/from the odd-numbered Y electrodes; and a second Y-electrode current path through which an electric current flows from/to the even-numbered Y electrodes in synchronization with and in a reverse direction to the flow of the electric current to/from the odd-numbered Y electrodes through the first Y-electrode current path.

### CROSS-REFERENCE TO RELATED APPLICATIONS

This application is based upon and claims the benefit of priority from the prior Japanese Patent Application No. 2004-152560, filed on May 21, 2004, the entire contents of which are incorporated herein by reference.

### BACKGROUND OF THE INVENTION

1. Field of the Invention

The present invention relates to a display device, and more particularly, to a display device having capacitances of display cells.

2. Description of the Related Art

A gas-discharge display device is a large and high-capacitance flat display, and has been increasingly coming on the market as a flat television for home use. For this device, the same level of power consumption, display quality, and cost as those of CRT are demanded.

Since an AC-type gas discharge panel has capacitances between display electrodes, charging/discharging occurs in the panel capacitances if a sustain discharge pulse is applied thereto. Therefore, in order to reduce charge/discharge loss, a method of resonating the panel capacitances and an inductor connected in series is adopted (see, for example, Patent documents 1 and 2).

Further, in order to eliminate fluctuation in LC resonant power supply voltage, Patent document 3 discloses a method in which column electrodes are grouped into even/odd electrodes or into a plurality of surface discharge electrode pairs, and the electrodes on the same side or the electrodes on the opposite sides in the plural surface discharge electrode pairs are directly resonated to reverse voltages. In this method, a resonant power supply capacitor is not basically necessary and the circuit length becomes shorter in a case of the resonance on the same terminal side of the panel. However, the waveform is limited by an LC resonant path, resulting in a lower degree of freedom in the waveform than that in a conventional circuit configuration, and an additional LC resonant circuit is necessary for a driving waveform immediately after resetting and addressing. In addition, wiring impedance to a gas discharge current is high in a large panel, but there is no effective way to reduce this.

The following patent documents 4 to 8 are also laid open.

[Patent document 1] Japanese Patent Application Laid-open No. Hei 5-265397

[Patent document 2] U.S. Pat. No. 5,670,974 (Japanese Patent Application Laid-open No. Hei 8-152865)

[Patent document 3] U.S. Pat. No. 6,072,447 (Japanese Patent Application Laid-open No. Hei 11-161226)

[Patent document 4] Japanese Patent Applciation Laid-open No. Hei 8-194320

[Patent document 5] U.S. Pat. No. 6,144,349 (Japanese Patent Application Laid-open No. Hei 11-85098

[Patent document 6] U.S. Pat. No. 6,686,912 (Japanese Patent Application Laid-open No. 2002-62844)

[Patent document 7] U.S. Pat. No. 5,828,353 (Japanese Patent Application Laid-open No. Hei 9-325735)

[Patent document 8] U.S. Pat. No. 5,081,400 (Japanese Patent Application Laid-open No. Sho 63-101897)

A large panel has a high panel capacitance and its gas discharge current is large, and in addition, wiring lines of the panel and driving circuits therein are long. As a result, problems of unstable discharge/deteriorated luminance due to the distortion of driving waveforms, inability of high-speed pulse application, large power loss, and so on become more prominent. In particular, inductance has a significant influence in the large panel, which poses other problems of electromagnetic-wave noise from the wiring lines and electromagnetic-wave noise caused by a sharp voltage rise of a distorted sustain discharge pulse due to voltage clamp. The prior arts have not attained sufficient solution to the waveform distortion that occurs when a sustain discharge voltage rises and when gas discharge is sustained, which has posed problems in terms of power consumption, luminance/light-emission efficiency, and electromagnetic-wave radiation noise.

### SUMMARY OF THE INVENTION

It is an object of the present invention to provide a display device capable of preventing waveform distortion, power loss, deterioration in light-emission efficiency and/or electromagnetic-wave noises.

According to one of the aspects of the present invention, provided is a display device including: a plurality of X electrodes consisting of odd-numbered electrodes and even-numbered electrodes; a plurality of Y electrodes consisting of odd-numbered electrodes and even-numbered electrodes, with capacitances being formed between the plural X electrodes and the plural Y electrodes; a first X-electrode current path through which an electric current flows to/from the odd-numbered X electrodes; a second X-electrode current path which is adjacent on a same substrate to the first X-electrode current path and through which an electric current flows from/to the even-numbered X electrodes in synchronization with and in a reverse direction to the flow of the electric current to/from the odd-numbered X electrodes through the first X-electrode current path; a first Y-electrode current path through which an electric current flows to/from the odd-numbered Y electrodes; and a second Y-electrode current path which is adjacent on a same substrate to the first odd-numbered Y electrodes and through which an electric current flows from/to the even-numbered Y electrodes in synchronization with and in a reverse direction to the flow of the electric current to/from the odd-numbered Y electrodes through the first Y-electrode current path.

### BRIEF DESCRIPTION OF THE DRAWINGS

FIG. 1 is a circuit diagram showing a configuration example of a plasma display device according to a first embodiment of the present invention;

FIG. 2 is a waveform chart showing an example of waveforms of sustain discharge voltages;

FIG. 3 is a waveform chart showing waveforms of sustain voltages according to a second embodiment of the present invention;

FIG. 4 is a waveform chart showing waveforms of sustain voltages according to a third embodiment of the present invention;

FIG. 5 is a circuit diagram showing a configuration example of a plasma display device according to a fourth embodiment of the present invention;

FIG. 6 is a waveform chart showing waveforms of sustain discharge voltages according to a fifth embodiment of the present invention;

FIG. 7 is a circuit diagram showing a configuration of a plasma display device;

FIG. 8 is a waveform chart showing waveforms of sustain discharge voltages;

FIG. 9 is a waveform chart showing waveforms of sustain discharge voltages;

FIG. 10 is a block diagram of a plasma display device;

FIG. 11A to FIG. 11C are cross-sectional views of a display cell of a plasma display;

FIG. 12 is a composition view of a frame of an image; and

FIG. 13 is a chart showing driving waveforms of the plasma display device.

### DETAILED DESCRIPTION OF THE PREFERRED EMBODIMENTS

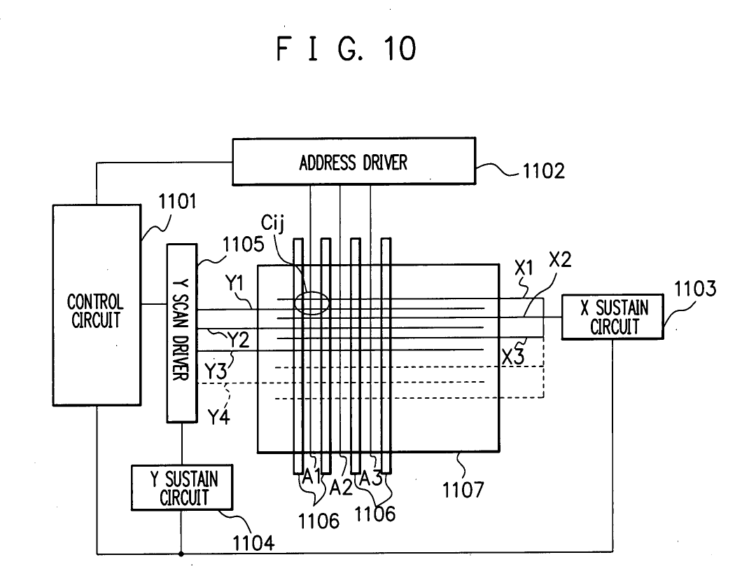

FIG. 10 is a view showing a basic configuration of a plasma display device. A control circuit 1101 controls an address driver 1102, a sustain electrode (X electrode) sustain (sustain-discharge) circuit 1103, a scanning electrode (Y electrode) sustain circuit 1104, and a scan driver 1105.

The address driver 1102 supplies a predetermined voltage to address electrodes A1, A2, A3, . . . Hereinafter, the address electrodes A1, A2, A3, . . . are each or collectively called an address electrode Aj, “j” being a suffix.

The scan driver 1105 supplies a predetermined voltage to scanning electrodes Y1, Y2, Y3, . . . according to the control by the control circuit 1101 and the scanning electrode sustain circuit 1104. Hereinafter, the scanning electrodes Y1, Y2, Y3, . . . are each or collectively called a scanning electrode Yi, “i” being a suffix.

The sustain electrode sustain circuit 1103 supplies the same voltage to the sustain electrodes X1, X2, X3, . . . . Hereinafter, the sustain electrodes X1, X2, X3, . . . are each or collectively called a sustain electrode Xi, “i” being a suffix. The sustain electrodes Xi are mutually connected and have the same voltage level.

In a display area 1107, the scanning electrodes Yi and the sustain electrodes Xi form rows horizontally extending in parallel to each other, and the address electrodes Aj form columns extending in a vertical direction. The scanning electrodes Yi and the sustain electrodes Xi are alternately arranged in the vertical direction. Ribs 1106 are disposed between the address electrodes Aj to have a stripe rib structure.

The scanning electrodes Yi and the address electrodes Aj form a two-dimensional matrix with i-rows by j-columns. Each display cell Cij is formed by an intersection of the scanning electrode Yi and the address electrode Aj and the sustain electrode Xi adjacent thereto. This display cell Cij corresponds to a pixel and the display area 1107 is capable of displaying a two-dimensional image.

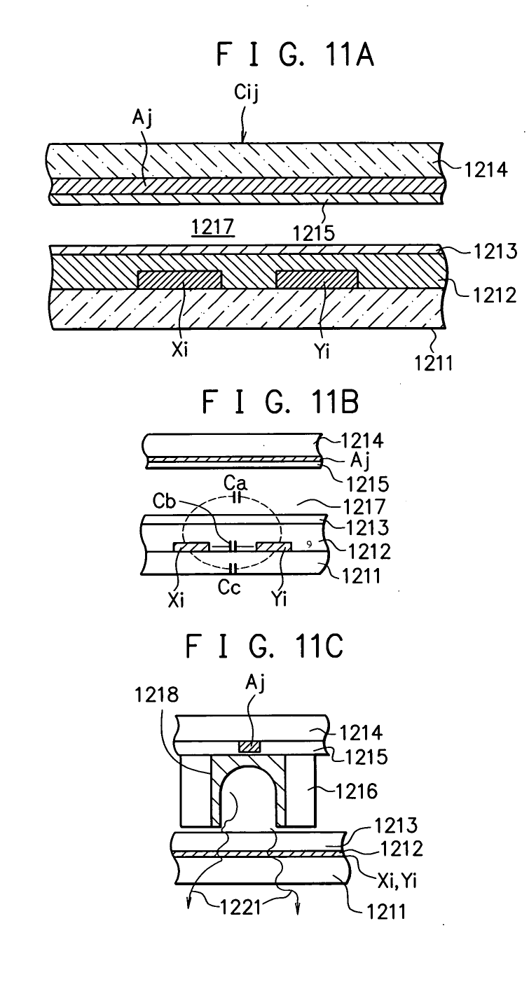

FIG. 11A is a cross-sectional view of the display cell Cij in FIG. 10. The sustain electrode Xi and the scanning electrode Yi are formed on a front glass substrate 1211. A dielectric layer 1212 intended for the insulation from a discharge space 1217 covers these electrodes, and it is further coated with a MgO (magnesium oxide) protective film 1213.

The address electrode Aj is formed on a back glass substrate 1214 facing the front glass substrate 1211. A dielectric layer 1215 is formed thereon, and it is further coated with a phosphor 1218. Ne+Xe Penning gas or the like is sealed in the discharge space 1217 between the MgO protective film 1213 and the dielectric layer 1215.

FIG. 11B is a view to describe a capacitance Cp of an AC driven plasma display. A capacitance Ca is a capacitance of the discharge space 1217 between the sustain electrode Xi and the scanning electrode Yi. A capacitance Cb is a capacitance of the dielectric layer 1212 between the sustain electrode Xi and the scanning electrode Yi. A capacitance Cc is a capacitance of the front glass substrate 1211 between the sustain electrode Xi and the scanning electrode Yi. The capacitance Cp between the sustain electrode Xi and the scanning electrode Yi is determined by the sum of these capacitances Ca, Cb, Cc.

FIG. 11C is a view to describe light emission of the AC driven plasma display. Striped-shaped red, blue, and green phosphors 1218 are arranged on and coats an inner surface of the rib 1216, and the phosphors 1218 are excited by discharge between the sustain electrode Xi and the scanning electrode Yi (discharge electrode pair) for pixel display to generate light 1221.

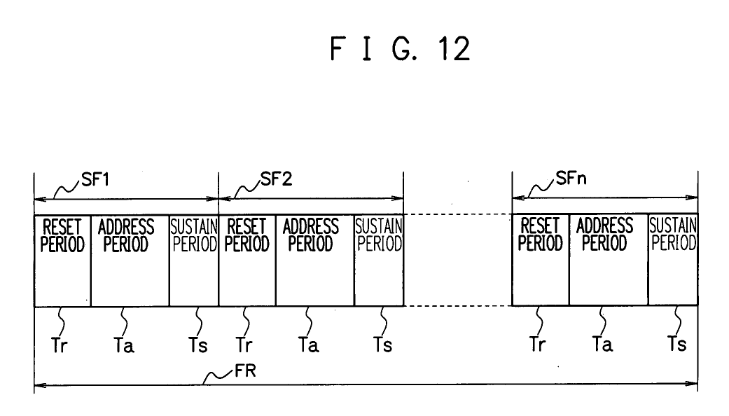

FIG. 12 is a composition view of one frame FR of an image. An image is formed at a rate of, for example, 60 frames/second. The frame FR is made up of a first sub-frame SF1, a second sub-frame SF2, . . . , an n^{th} sub-frame SFn. This “n” is, for example, 10 and corresponds to the number of tone bits. The sub-frames SF1, SF2, and so forth are each or collectively called a sub-frame SF.

Each of the sub-frames SF is made up of a reset period Tr, an address period Ta, and a sustain period (sustain discharge period) Ts. In the reset period Tr, the display cells are initialized. In the address period Ta, lighting or non-lighting of each of the display cells can be selected according to address designation. The selected cells emit light in the sustain period Ts. The number of times of light emission (the number of sustain pulses) in the sustain period Ts differs depending on each sub-frame SF. The sum of the number of times of light emission in the frame FR determines a tone value of the pixel.

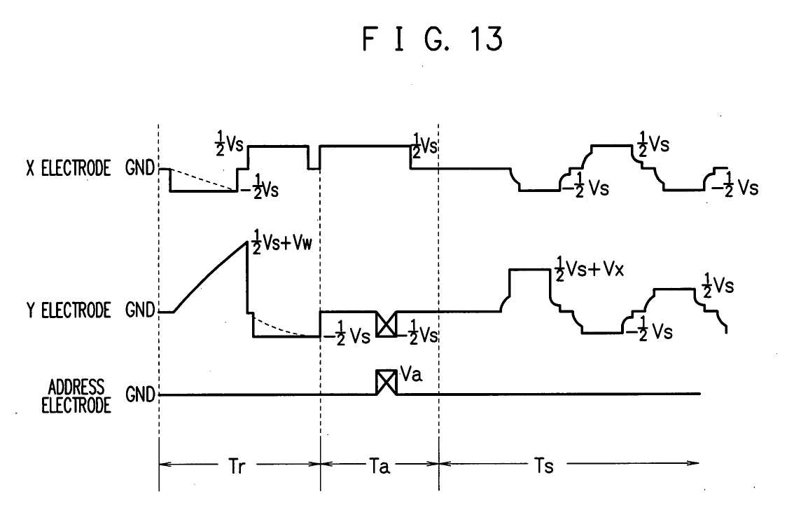

FIG. 13 is a waveform chart in the sub-frame SF shown in FIG. 12. FIG. 13 shows an example of waveforms of voltages applied to the X electrodes, the Y electrodes, and the address electrodes, for one sub-frame among the plural sub-frames constituting one frame. One sub-frame is divided into the reset period Tr composed of a full write period and a full erase period, the address period Ta, and the sustain period Ts.

In the reset period Tr, a voltage applied to the sustain electrodes X is first dropped from a ground level to (−Vs/2). Meanwhile, a voltage equal to the sum of a voltage Vw and a voltage (Vs/2) is applied to the scanning electrodes Y. At this time, the voltage (Vs/2+Vw) gradually rises with time. Consequently, a difference in potential between the sustain electrodes X and the scanning electrodes Y becomes (Vs+Vw) and discharging occurs in all the cells of all display lines regardless of a previous display state, so that wall charges are formed (full write).

Next, after the voltages of the sustain electrodes X and the scanning electrodes Y are returned to the ground level, the voltage applied to the sustain electrodes X is raised from the ground level to (Vs/2) and at the same time, the voltage applied to the scanning electrodes Y is dropped to (−Vs/2). Consequently, the voltage of the wall charges themselves exceeds a discharge start voltage in all the cells, so that discharging is started. At this time, the accumulated wall charges are erased by the voltage applied to the sustain electrodes X (full erase) as described above.

Next, in the address period Ta, address discharge is performed line by line in order to turn on/off each of the cells according to display data. At this time, a voltage (Vs/2) is applied to the sustain electrodes X. Further, when a voltage is applied to the scanning electrode Y corresponding to a given display line, a (−Vs/2) level voltage is applied to the scanning electrode Y selected through line-by-line selection, and a ground-level voltage is applied to the unselected scanning electrodes Y.

At this time, an address pulse of a voltage Va is selectively applied to an address electrode Aj, out of the address electrodes A1 to Am, corresponding to a cell for sustain discharge, namely, a cell to be lighted. As a result, discharging occurs between the address electrode Aj of the cell to be lighted and the scanning electrode Y selected through the line-by-line selection, and triggered by this discharge as a priming (pilot flame), discharging immediately occurs between the sustain electrode X and the scanning electrode Y. As a result, wall charges in amount sufficient for the next sustain discharge are accumulated on a surface of the MgO protective film on the sustain electrode X and the scanning electrode Y of the selected cell.

In the subsequent sustain period TS, a power recovery circuit operates to gradually raise the voltage of the scanning electrodes Y. Then, the voltage of the scanning electrodes Y is clamped at (Vs/2+Vx) near the peak of the rise.

On the other hand, the voltage of the sustain electrodes X gradually drops. At this time, the power recovery circuit recovers part of the electric charges thereof. Then, near the peak of the drop, the voltage of the sustain electrodes X is clamped at (−Vs/2). For changing the voltages applied to the sustain electrodes X and the scanning electrodes Y from (−Vs/2) to the ground level (0 V), the applied voltages are similarly gradually raised. Further, the voltage (Vs/2+Vx) is applied to the scanning electrode Y only at the first high-voltage application, and the high voltage thereafter applied thereto is set to Vs/2. Note that the voltage Vx is an extra voltage that is added to the voltage of the wall charges generated in the address period Ta shown in FIG. 13 to generate a voltage necessary for the sustain discharge.

Further, for changing the voltages applied to the sustain electrodes X and the scanning electrodes Y to the ground level (0 V) from the voltage (Vs/2), the applied voltages are gradually dropped and the power recovery circuit recovers part of the electric charges accumulated in the cells.

Thus, in the sustain period Ta, voltages different in polarity (+Vs/2, −Vs/2) are alternately applied to the sustain electrode X and the scanning electrode Y of each display line to cause the sustain discharge, thereby displaying an image corresponding to one sub-frame. Note that the operation of alternate voltage application is called a sustain operation.

### First Embodiment

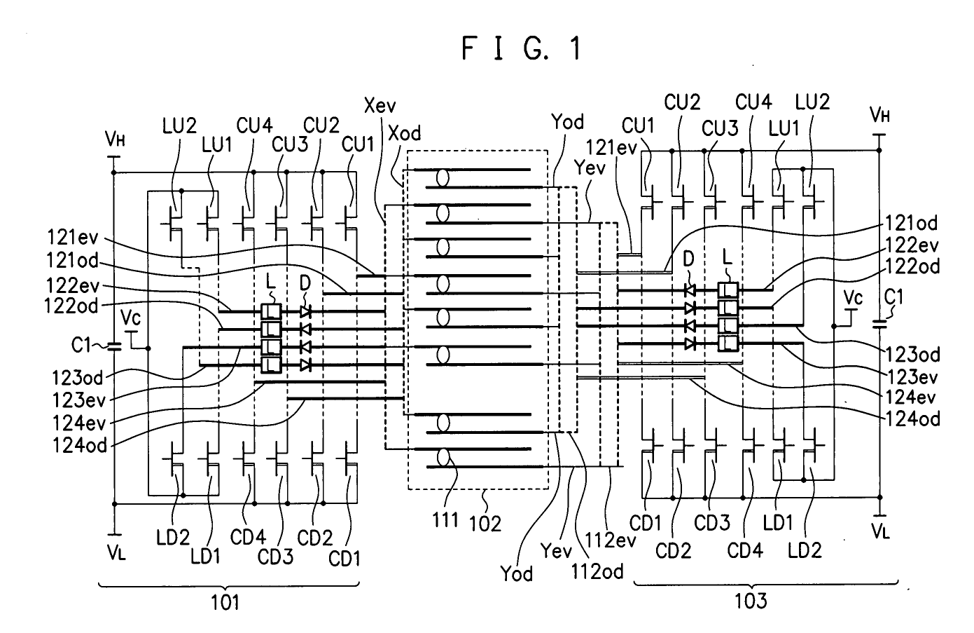

FIG. 1 is a circuit diagram showing a configuration example of a plasma display device (gas-discharge display device) according to a first embodiment of the present invention. The display device has an X-side driving circuit 101, a panel 102, and a Y-side driving circuit 103. The X-side driving circuit 101 corresponds to the X sustain circuit 1103 in FIG. 10, the panel 102 corresponds to the display panel 1107 in FIG. 10, and the Y-side driving circuit 103 corresponds to the Y sustain circuit 1104. The driving circuits 101 and 103 are capable of generating sustain discharge pulses in the sustain period Ts in FIG. 13. Scan drivers 112ev and 112od correspond to the scan driver 1105 in FIG. 10.

First, the structure of the panel 102 will be described. A plurality of X electrodes are connected to the X-side driving circuit 101. A plurality of Y electrodes are connected to the Y-side driving circuit 103. The plural X electrodes and the plural Y electrodes are alternately arranged in parallel to one another. Out of the X electrodes, odd-numbered electrodes X1, X3, X5, and so forth will be called Xod electrodes, and even-numbered electrodes X2, X4, X6, and so forth will be called Xev. The odd-numbered Xod electrodes are mutually connected and the same voltage is applied thereto. The even-numbered Xev electrodes are mutually connected and the same voltage is applied thereto. Further, out of the Y electrodes, odd-numbered electrodes Y1, Y3, Y5, and so forth will be called Yod electrodes and even-numbered electrodes Y2, Y4, Y6, and so forth will be called Yev electrodes. The odd-numbered Yod electrodes are mutually connected and the same voltage is applied thereto and the even-numbered Yev electrodes are mutually connected and the same voltage is applied thereto. A discharge cell (display cell) 111 is formed between the electrode X1 and the electrode Y1, and another discharge cell 111 is formed between the electrode X2 and the electrode Y2, and so forth. That is, the discharge cells 111 are formed between the Xod-electrodes and the Yod electrodes, and the discharge cells 111 are formed between the Xev electrodes and the Yev electrodes. Each of the discharge cells 111 has a panel capacitance C between the X electrode and the Y electrode.

Next, a configuration common to the X-side driving circuit 101 and the Y-side driving circuit 103 will be described. Hereinafter, an n-channel MOS (metal-oxide semiconductor) electric field effect transistor (FET) will be simply called a FET. A CU1 is a FET having a drain connected to a high voltage VH and a source connected to a clamp path 121ev. A CU2 is a FET having a drain connected to the high voltage VH and a source connected to a clamp path 121od. A CU3 is a FET having a drain connected to the high voltage VH and a source connected to a clamp path 124od. A CU4 is a FET having a drain connected to the high voltage VH and a source connected to a clamp path 124ev.

A CD1 is a FET having a source connected to a low voltage VL and a drain connected to the clamp path 121ev. A CD2 is a FET having a source connected to the low voltage VL and a drain connected to the clamp path 121od. A CD3 is a FET having a source connected to the low voltage VL and a drain connected to the clamp path 124od. A CD4 is a FET having a source connected to the low voltage VL and a drain connected to the clamp path 124ev.

A LU1 is a FET having a drain connected to a power supply voltage Vc (for example, (VH+VL)/2) and a source connected to a charge path 122ev. A LU2 is a FET having a drain connected to the power supply voltage Vc and a source connected to a charge path 123od. The charge path (current path) 122ev has an inductor L and a diode D connected in series and is connected to the Xev/Yev electrodes. The diode D has an anode connected to a power supply voltage Vc side and a cathode connected to a panel capacitance C side, and an electric current can flow therethrough in a direction for charging the panel capacitances C. The discharge path 123od has an inductor L and a diode D connected in series and is connected to the Xod/Yod electrodes. The diode D has an anode connected to a power supply voltage Vc side and a cathode connected to a panel capacitance C side, and an electric current can flow therethrough in the direction for charging the panel capacitances C. Each of the charge currents flows in a direction from the power supply voltage Vc to the panel capacitances C due to LC resonance of the inductor L and the panel capacitances C.

An LD1 is a FET having a source connected to the power supply voltage Vc and a drain connected to a discharge path 122od. An LD2 is a FET having a source connected to the power supply voltage Vc and a drain connected to a discharge path 123ev.

The discharge path (current path) 122od has an inductor L and a diode D connected in series and is connected to the Xod/Yod electrodes. The diode D has a cathode connected to a power supply voltage Vc side and an anode connected to a panel capacitance C side, and an electric current can flow therethrough in a direction for discharging the panel capacitances C. The discharge path 123ev has an inductor L and a diode D connected in series and is connected to the Xev/Yev electrodes. The diode D has a cathode connected to a power supply voltage Vc side and an anode connected to a panel capacitance C side, and an electric current can flow therethrough in a direction for discharging the panel capacitances C. Each of the discharge currents flows from the panel capacitance C to the power supply voltage Vc due to LC resonance of the inductor L and the panel capacitances C.

The clamp paths (current paths) 121ev and 121od make a pair and are adjacent to each other in parallel. For turning on the FET of the CU1, the FET of the CD2 is turned on. A charge current flows through the clamp path 121ev and a discharge current flows through the clamp path 121od. The electric currents flow in reverse directions through the clamp paths 121ev and 121od, so that magnetic fields thereof are cancelled out by each other. Conversely, when a discharge current flows through the clamp path 121ev, a charge current flows through the clamp path 121od to cancel out magnetic fields by each other. Similarly, the clamp paths 124ev and 124od make a pair and electric currents flow therethrough in reverse directions to each other, so that magnetic fields are cancelled out by each other.

Further, the charge path 122ev and the discharge path 122od make a pair. When a charge current flows through the charge path 122ev, a discharge current flows through the discharge path 122od to cancel out magnetic fields. Further, the charge path 123od and the discharge path 123ev make a pair. When a charge current flows through the charge path 123od, a discharge current flows through the discharge path 123ev to cancel out magnetic fields.

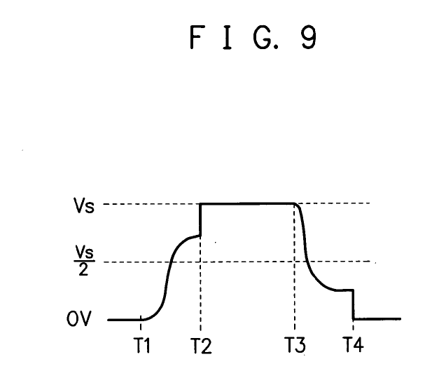

FIG. 9 is a waveform chart to describe an example of generating a sustain discharge pulse. The sustain discharge pulse of the Xod electrodes is taken as an example for description. Before a time T1, only the FETs of the CD2 and CD3 are turned on to set the Xod electrodes to 0 V (VL). Next, at the time T1, only the FETs of the LU2 is turned on to raise the voltage of the Xod electrodes nearly to Vs (VH) by LC resonance. Next, at a time T2, only the FETs of the CU2 and the CU3 are turned on to clamp the Xod electrodes at Vs. Next, at a time T3, only the FET of the LD1 is turned on to discharge the Xod electrodes nearly to 0 V by LC resonance. Next, at a time T4, only the FETs of the CD2 and the CD3 are turned on to clamp the Xod electrodes at 0 V.

As described above, as seen in FIG. 1, the high voltage and low voltage of the sustain pulse are VH and VL respectively; the LC resonant power supply voltage is Vc; the FETs for charging the panel capacitances of the X/Y electrodes by LC resonance are LU1/LU2; the FETs for discharging the panel capacitances of the X/Y electrodes by LC resonance are the LD1/LD2; the FETs for high-voltage clamp of the X/Y electrodes are the CU1/CU2/CU3/CU4; and the FETs for low-voltage clamp of the X/Y electrodes are the CD1/CD2/CD3/CD4. The resonant inductor L and the diode D for preventing backflow are mounted between each of the FETs for LC resonance and panel terminals, and a large-capacity capacitor C1 is mounted between the high voltage VH and the low voltage VL.

The odd-side Yod scan driver 112od and the even-side Yev scan driver 112ev are disposed in the Y-side driving circuit 103, and the Y-side discharge sustain pulse is directly applied to the Y electrodes through diodes in the scan drivers. The X-side and Y-side driving circuits 101 and 103 are mounted on one printed board and another printed board respectively, and component arrangement/wiring patterns are designed so that wiring lines of the LC resonant circuits and the voltage clamp circuits are divided into predetermined pairs, which are substantially parallel on the printed boards.

As shown in FIG. 1, each of the display cells 111 is formed between the display electrode pair X/Y of the 3-electrode surface discharge AC-type color panel, and the electrode terminals are alternately drawn out. The driving circuits are separately disposed on the X-electrode driving printed board and the Y-electrode driving printed board. Each of the driving circuits is divided into an odd-line (Xod/Yod) block and an even-line (Xev/Yev) block. Each of the blocks is composed of one line of an LC-resonant panel-capacitance charge circuit, one line of a panel capacitance discharge circuit, and two lines of high-voltage/low-voltage clamp circuits. In the LC resonant circuit, the capacitance charge path for the odd display electrodes and the capacitance discharge path for the even display electrodes make a pair, and the capacitance discharge path for the odd display electrodes and the capacitance charge path of the even display electrodes make a pair. Similarly, in the voltage clamp circuit, the clamp path for the odd display electrodes and the clamp path for the even display electrodes are divided into plurality to make pairs respectively. The wiring lines of the pair of driving circuits are arranged in parallel. The LC resonant power sources on the charge side and on the discharge side of the X and Y driving circuits 101 and 103 are connected to each other with low impedance, and the large-capacity capacitor C1 is connected with low impedance between the X/Y high-voltage clamp power source and low-voltage clamp power source. In the voltage clamp circuit, similarly to the LC resonant circuit, element arrangement/patterns are designed so that directions of electric currents in a pair of lines are reverse to each other with later-described driving waveforms.

The scan driver 112ev and 112od are disposed on the Y-electrode side, but similarly to the X-side, a display sustain pulse is generated by the rise/drop of a high-voltage pulse by LC resonance and by the high/low-voltage clamp circuit. Each of the LC resonant circuits has the inductor L and the diode D between the panel 102 and the switching FET, so that the peak voltage is maintained after the end of the resonance to prevent the backflow of the electric current. The resonant frequency generated by the series connection of the panel capacitance C and the inductor L is about 2 MHz and the rise/drop of the sustain voltage pulse occurs at a time interval of about 0.3 μs. On the power source (Vc) side of the LC resonant circuit, the charge side and the discharge side are connected to each other with low impedance in the same substrate, and they are generally grounded through a capacitor, though not shown in the drawing. The high-voltage power source VH and the low-voltage power source VL are connected to external power sources, and are connected to both ends of the large-capacity capacitor C1 with low impedance, respectively. The address electrode A1 and so forth, the address driver 1102, and so on in FIG. 10 are the same as those in FIG. 10, though not described since they do not directly relate to the operations of this embodiment.

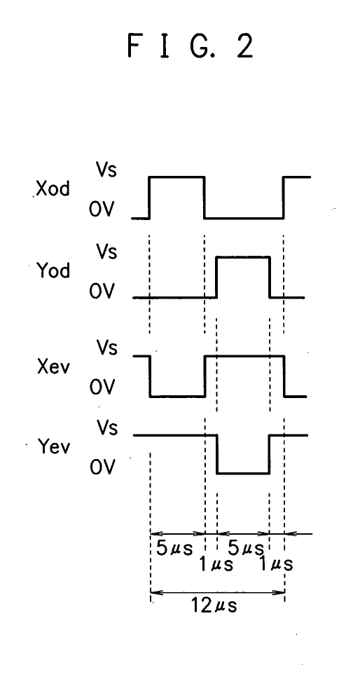

FIG. 2 is a waveform chart showing an example of waveforms of the sustain discharge voltages. It shows one cycle (12 μs) of the voltage waveforms of the sustain discharge pulse of the 3-electrode surface discharge panel. They are driving waveforms with which LC resonant currents flow concurrently in the Xod and Yev electrodes and a gas discharge current between the Xod-Yod and that between the Yev-Xev concurrently flow in reverse directions. The voltage Vs of the discharge sustain pulse is a voltage at which sustain discharge occurs in the addressed discharge cells having wall charges and discharge does not occur in the discharge cells not addressed.

While the Yod is kept at 0 V and the Yev is kept at Vs, the Xod voltage is raised from 0 V to Vs and at the same time, the Xev voltage is dropped from Vs to 0 V. This causes the sustain discharges to occur concurrently from the Xod electrodes to the Yod electrodes, and from the Yev electrodes to the Xev electrodes. After this state is maintained for 5 μs, these voltages are dropped and raised respectively. After 1 μs passes, the Yod voltage is raised from 0 V to Vs and at the same time, the Yev voltage is dropped from Vs to 0 V. This causes the sustain discharges to concurrently occur from the Yod electrodes to the Xod electrodes and from the Xev electrodes to the Yev electrodes. After this state is maintained for 5 μs, these voltages are dropped and raised respectively. From the start up to 1 μs afterward from here is defined as one cycle. When the sustain pulse is continuously applied, the sustain discharge occurs in the addressed cells the number of cycles×2 times. Display luminance is substantially proportional to the number of times of discharge, and dividing an image into the plural sub-frames for display enables multi-tone display.

The following description will be on a case where the driving circuits in FIG. 1 apply the discharge sustain pulse with the driving waveforms in FIG. 2 to the display electrodes of the panel. Here, the timing for raising the Xod voltage from 0 V to Vs will be discussed, assuming that VH=Vs (about 160 V), VL=0 V, and Vc=Vs/2.

When the FET of the LU2 of the X-side driving circuit 101 is turned on while the FETs of the CD2 and the CD3 of the Y-side driving circuit 103 are ON (Yod=0 V, Yev=Vs), an electric current flows between Vc (Vs/2) and the Xod (0 V) through the Xod inductor L, and the panel capacitances C between the Xo electrodes and the Y electrodes resonate (\overline{ω}=½π√LC) with the inductor L, so that the Xod electrode potential rises from 0 V nearly to Vs. When the peak voltage is reached, the electric current tries to flow back, but the voltage is held at the peak value due to the existence of the series diode D. At the same timing, when the FET of the LD2 of the X-side driving circuit 101 is turned on, an electric current flows between the Xev (Vs) and the Vc (Vs/2) through the Xev inductor L, and the panel capacitances C between the Xev electrodes and the Y electrodes resonate (\overline{ω}=½π√LC) with the inductor L, so that the Xev electrode potential drops from Vs nearly to 0 V. When the minimum voltage is reached, the electric current tries to flow back, but the voltage is held at the minimum value due to the existence of the series diode D. Assuming that the panel capacitance is 100 nF and the coil inductance is 100 nH, the peak voltages are reached in about 300 ns. Synchronously with the timing at which the peak voltages are almost reached, the FETs of the CU2/CU3 of the X-side driving circuit 101 and the FETs of the CD1/CD4 of the X-side driving circuit 101 are turned on to keep the Xod electrodes at Vs and the Xev electrodes at 0 V. Immediately after the Xod electrode voltage reaches Vs and the Xev electrode voltage reaches 0 V, gas discharge for display sustain occurs between the Xod-Yod electrodes and between the Xev-Yev electrodes in the addressed discharge cells 111 in which the sustain discharge is occurring, so that the discharge current flows from the CU2/CU3 of the X-side driving circuit 101 to the CD2/CD3 of the Y-side driving circuit 103, and from the CU1/CU4 of the Y-side driving circuit 103 to the CD1/CD4 of the X-side driving circuit 101.

After the Xod/Xev voltages are kept for 5 μs, the CU2/CU3 of the X-side driving circuit 101 and the CD1/CD4 of the X-side driving circuit 101 are turned off, and the LD1 of the X-side driving circuit 101 and the LU1 of the X-side driving circuit 101 are turned on. Similarly, after the voltages are reversed due to the LC resonance and the peak voltages are almost reached, the CD2/CD3 of the X-side driving circuit 101 and the CU1/CU4 of the X-side driving circuit 101 are turned on to clamp the voltages at 0 V and Vs. At this time, no display current for gas discharge flows.

In the same manner, when the Yod voltage is raised and the Yev voltage is dropped after 1 μs passes and the voltages are clamp thereafter, gas discharge occurs in the discharging cells 111. After the voltage is kept for 5 μs, a voltage reversed pulse is repeatedly applied for display discharge.

Characteristics and effects of the circuit will be discussed below in detail. When the voltage rise of the Xod electrodes and the voltage drop of the Xev electrodes concurrently take place, a charge current to the Xod electrodes and a discharge current from the Xev electrodes become completely equal to each other because LC resonance cycle/voltage/current are the same. As for the LC resonant power source Vc, the charge current to the panel capacitances C flows therefrom through the FET of the LU2 of the X-side driving circuit 101, and the discharge current from the panel capacitances C flows thereto through the FET of the LD2 of the X-side driving circuit 101, so that the voltage of the power source Vc does not change even if impedance from an external power supply is large. Further, due to the adjacent and parallel arrangement of the wiring lines of the LC charge circuit for the Xod electrodes and the LC discharge circuit for the Xev electrodes, the flows of the electric currents therethrough in reverse directions cancel out magnetic fields. This reduces equivalent wiring inductance, and thus it can be considered that charging/discharging of the capacitances C are caused by the pure resonance of the panel capacitances and the series inductor L.

As a result, waveform distortion does not occur when the X voltage is raised/dropped, enabling not only a high-speed operation but also reduction in power loss in charging/discharging the capacitances. Assuming that the panel capacitance is 200 nF and the sustain discharge pulse is 400 kHz, total power consumption is about 520 W if there is no power recovery by LC resonance. In prior arts, the LC resonant voltage ultimately reached is about 80% of the peak voltage and power consumption is about 100 W. This embodiment has attained the ultimate voltage of about 151 V and power consumption of about 80 W, and thus can make about 20% improvement.

Discharging occurs in the display cells after the voltage rise of the Xod electrodes, so that the gas discharge current flows from the CU2/CU3 of the X-side driving circuit 101 to the CD2/CD3 of the Y-side driving circuit 103, and from the CU1/CU4 of the Y-side driving circuit 103 to the CD1/CD4 of the X-side driving circuit 101. Nevertheless, due to the parallel arrangement of the current paths, if the number of the display cells is the same, namely, if the electric currents flowing therethrough are substantially equal, the magnetic fields caused by the electric currents flowing through the wiring lines are cancelled out, resulting in reduction in equivalent wiring inductance. Further, in the X-side driving circuit 101, the electric current flowing from the high-voltage power source VH (Vs) and the electric current flowing to the low-voltage power source VL (0 V) are substantially equal, so that even large wiring impedance of the external power source would cause only small fluctuation in potential difference if the capacitor capacitance C1 between Vs and the ground (VH-VL) is large. As a result, even the flow of a large, pulsed gas discharge current would cause only a small drop/fluctuation in the voltage applied to the display cells and cause no deterioration in luminance/light-emission efficiency and no unstable discharge, resulting in improved performance.

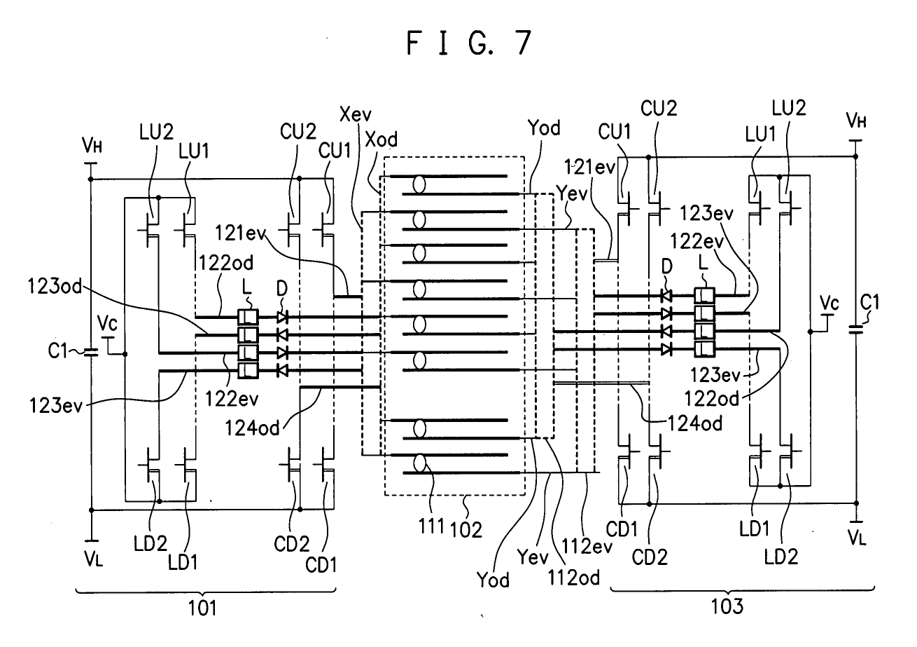

FIG. 7 shows a configuration of a plasma display device for comparison with that in FIG. 1. What are different in the device in FIG. 7 from the device in FIG. 1 will be described. The device in FIG. 7 does not have the FETs of the CU3, CU4, CD3, CD4 in FIG. 1. Further, clamp paths 121ev and 124od are not adjacent to each other and thus do not make a pair, so that magnetic fields cannot be cancelled out.

Further, a charge path 122od and a discharge path 123od for an Xod/Yod electrode are generally adjacent to each other to make a pair. However, since only one of charging in the charge path 122od and discharging in the discharge path 123od takes place and both do not coincide, so that magnetic fields cannot be cancelled out. Similarly, since a charge path 122ev and a discharge path 123ev for an Xed/Yev electrode are adjacent to each other to make a pair, charging and discharging do not coincide, so that magnetic fields cannot be cancelled out.

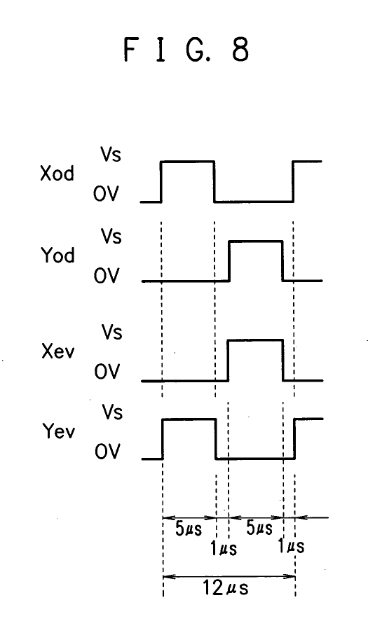

FIG. 8 is a waveform chart showing waveforms of sustain discharge voltages for comparison with those in FIG. 2. The rise/drop timing of the Xod electrodes and the rise/drop timing of the Yod electrodes are different. Further, the rise/drop timing of the Xev electrode and the rise/drop timing of the Yev electrodes are different. This is what is different from the waveforms of the sustain discharge voltages in FIG. 2.

This embodiment relates to a display device for realizing high-speed driving of an AC-type color PDP and can realize reduction in circuit loss, improvement in light-emission efficiency, and stability in operation. The display device includes the display sustain electrode pairs X and Y of the AC-type gas discharge panel. A display cell on an n^{th} display line is formed between Xn and Yn, and barrier walls or the like prevent discharge between the display cells. The driving circuit applying a discharge sustain voltage pulse to the panel is constituted of: the LC resonant circuit that causes the inductor L series-connected to the panel capacitances C to resonate with the panel capacitances C between the X-Y electrodes, thereby charging/discharging the panel capacitances C to a predetermined voltage; and the high-voltage/low-voltage clamp circuit for keeping the voltage applied to the panel at a constant level. The LC resonant circuit and the voltage clamp circuit on one side (X or Y) are formed on one printed board. As for the discharge sustain voltage pulse, the voltage pulse of the X even line (Xev) is dropped from the high voltage VH to the low voltage VL in synchronization with the rise of the voltage pulse of the X odd line (Xod) from the low voltage VL to the high voltage VH. Conversely, the Xev voltage is raised from the low voltage VL to the high voltage VH in synchronization with the drop of the Xod voltage from the high voltage VH to the low voltage VL. At this time, the potential of the Y electrodes is not varied at the timing at which the potential of the X electrodes is varied.

When the Xod electrode voltage is raised, the charge-side FET of the LC resonant circuit is turned on to cause the resonance of the panel capacitances C and the series inductor L, thereby charging the panel capacitances C from the resonant power supply capacitor at the intermediate voltage Vc between the high voltage VH and the low voltage VL. The resonant frequency is in inverse proportion to a square root of C×L, and the voltage of the electrode terminals Xod of the panel capacitances C rises from the low voltage VL to the high voltage VH if there is no circuit loss by resistance and the like.

The diode D is series-connected to the charge circuit, so that the potential of the electrode terminals Xod is kept at the high voltage. However, when the voltage between the electrodes (Xod-Yod) of the discharge cells becomes equal to or higher than the discharge start voltage, the discharge is started, and the flow of the discharge current would lower the potential of the Xod. Therefore, the FET of the high-voltage clamp circuit is turned on after the voltage is sufficiently raised by the LC resonance, thereby keeping the potential of the Xod at the high voltage VH.

In order to drop the potential of the Xev electrodes from the high voltage VH to the low voltage VL in synchronization with the rise of the Xod voltage, the discharge-side FET of the LC resonant circuit for the Xev is turned on to cause the resonance of the panel capacitances C and the series inductor L, thereby discharging the electric charges, which have been accumulated in the panel capacitances C at the high voltage VH, to the resonant power supply capacitor at the intermediate voltage Vc between the high voltage VH and the low voltage VL. Similarly to the case of charging the Xod, the resonant frequency is in inverse proportion to a square root of C×L, and the electrode terminals Xev of the panel capacitances C drops from the high voltage VH to the low voltage LH if there is no circuit loss by resistance and the like. The voltage of the Xev terminals is kept at the low voltage VL owing to the series diode D. However, in order to prevent voltage fluctuation that might thereafter occur by gas discharge, the low-voltage clamp FET for the Xev is turned on to keep the Xev voltage at the low voltage VL.

The change of the Xod potential from the low voltage VL to the high voltage HL and the change of the Xev potential from the high voltage to the low voltage also follow the similar procedure. At the timing when the Xod potential is changed to the high voltage VH and the Xev potential is changed to the low voltage VL, the low-voltage clamp FET is turned on to keep the Yod at the low voltage VL, and the high-voltage clamp FET is turned on to keep the Yev at the high voltage VH. Similarly, a voltage pulse is also applied to the Yod/Yev electrodes, and the voltage pulse is alternately applied to the X/Y electrodes.

Setting the voltage (VH-VL) between the X-Y of the discharge cells to the discharge sustain voltage Vs that is the typical voltage in AC-type memory driving will realize AC-type memory driving display in which only the addressed discharge cells having wall charges on their display electrodes continue discharging.

In the above-described panel structure and driving circuits/driving waveforms, if a circuit constant is the same, the LC resonant current for the rise of the Xod and that for the drop of the Xev are equal. Similarly, the LC resonant currents for the rise of the Xod and the drop of the Xev are equal. Since the LC resonant currents of the Xod and Xev are in same size and in opposite phases, so that even the rise/drop of the Xod/Xev voltages by the LC resonance would not cause an electric current to flow from/to the LC resonant power supply capacitor Vc, resulting in no fluctuation in Vc voltage. The same applies to the Yod/Yev. Further, the plural wiring lines of the driving circuits and panel for the charge current to the Xod capacitances and the discharge current from the Yod capacitances are substantially parallel to one another. Therefore, if electric currents flow therethrough in reverse directions, magnetic fields are cancelled out by one another, resulting in reduced wiring inductance. With such driving circuits/driving waveforms, the LC resonant power supply voltage does not fluctuate and unnecessary wiring inductance of the circuits/panel is small. This enables LC resonance as designed, improved power recovery efficiency, and reduced power consumption.

In the cells that have been addressed and are discharging, sustain discharge continuously occurs, but immediately after the potential of the Xod electrodes changes to the high voltage, discharge occurs between the Xod-Yod electrodes, so that the discharge current flows from the high-voltage clamp power source for the Xod to the low-voltage clamp power source for the Yod. Further, at the same timing, the potential of the Xev changes to the low voltage, so that the discharge current flows from the high-voltage clamp power source for the Yev to the low-voltage clamp power source for the Xev.

When the number of the lighted cells between the Xod-Yod electrodes and that between the Xev-Yev electrodes are the same, the electric current flowing from the Xod to the Yod is equal to the electric current flowing from the Yev to the Xev. In this case, if the large capacitor C1 is mounted between the high-voltage power source VH and the low-voltage power source VL on the driving circuit board, electric currents equal in size flow to the low-voltage side and from the high-voltage side of the capacitor C1, so that voltages at both ends of the power supply capacitor do not fluctuate even without any current supply from an external power supply circuit. The plural wiring lines of the driving circuits and panel for the discharge currents flowing from the Xod to the Yod and from the Yev to the Xev are substantially parallel to one another. Further, electric currents substantially equal in size flow in reverse directions if the number of the display cells between the Xod-Yod electrodes is substantially the same as that between the Xev-Yev electrodes. Consequently, magnetic fields caused by the electric currents are cancelled out by one another, so that wiring inductance is reduced. Even if a large, pulsed discharge current flows, voltage distortion/drop due to fluctuation in power supply voltage and wiring inductance is small, and the voltage between the XY electrodes can be maintained, resulting in stable sustain discharge and no luminance deterioration.

Incidentally, this embodiment has described the case where a pair of the clamp paths 121ev and 121od and a pair of the clamp paths 124ev and 124od are provided. However, only one of the pairs may be provided.

### Second Embodiment

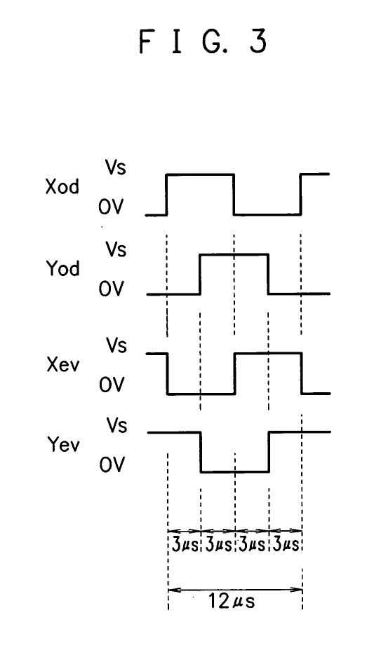

FIG. 3 shows a waveform chart of waveforms of sustain voltages according to a second embodiment of the present invention. One cycle is, for example, 12 μs. A voltage of the Xev electrodes is dropped synchronously with the voltage rise of Xod electrodes. 3 μs later, the voltage of the Yod electrodes is raised and at the same time, the voltage of the Yev electrodes is dropped. 3 μs later, the voltage of the Xod electrodes is dropped and at the same time, the voltage of the Xev electrodes is raised. 3 μs later, the voltage of the Yod electrodes is dropped and at the same time, the voltage of the Yev electrodes is raised. 3 μs later, the above processes are repeated from the beginning.

This embodiment can offer the same effects as those of the waveforms in FIG. 2. That is, this embodiment can provide the effects of lowering wiring impedance and reducing fluctuation in power supply voltage related to LC resonance and gas discharge current, similarly to FIG. 2. In the waveforms in this embodiment, the ON times of the respective FETs of the Xod electrodes and the Yev electrodes, and the Yod electrodes and the Xev electrodes are equal, which eliminates nonuniformity in heat generation of the FETs and facilitates thermal design. A time-averaged voltage between the electrodes is 0 (zero) and there is no risk of migration between the electrodes. This embodiment can realize uniform heat generation of driving elements and has no risk of migration between electrodes.

### Third Embodiment

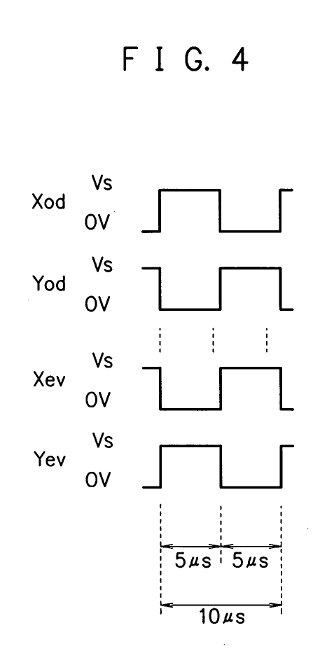

FIG. 4 is a waveform chart showing waveforms of sustain voltages according to a third embodiment of the present invention. Driving waveforms in this embodiment are such that an LC resonant current between the Xod-Xev and that between the Yod-Yev flow concurrently in reverse directions, and a gas discharge current between the Xod-Yod and that between the Yev-Xev concurrently flow in reverse directions. Voltage changes of the Xod from 0 V to Vs, of the Yod from Vs to 0 V, of the Xev from Vs to 0 V, and of the Yev from 0 V to Vs are synchronized, and after this state is maintained for 5 μs, voltage changes of the Xod from Vs to 0 V, of the Yod from 0 V to Vs, of the Xev from 0 V to Vs, and of the Yev from Vs to 0 V are synchronized. This state is maintained for 5 μs, and the process up to here is defined as one cycle of sustain discharge. These driving waveforms can more easily realize higher-speed driving than the driving waveforms in FIG. 2 and FIG. 3.

Next, the voltage rise timing of the Xod electrodes from 0 V to Vs will be described. The FETs of the LU2 of the X-side driving circuit 101, the LD2 of the X-side driving circuit 101, the LU1 of the Y-side driving circuit 103, and the LD1 of the Y-side driving circuit 103 are concurrently turned on, and the other FETs are all turned off. At this time, an electric current flows from the LC resonant power source (Vs/2) to the Xod electrodes (0 V) of the panel capacitances C through the LU2 of the X-side driving circuit 101 and the Xod inductor L. At the same time, an electric current flows from the Yod electrodes (Vs) of the panel capacitances C to the LC resonant power source (Vs/2) through the Yod inductor L and the LD1 of the Y-side driving circuit 103. Consequently, the Xod voltage and the Yod voltage are substantially reversed by LC resonance (ω=½π√LC), and they are held at the peak voltages by the diodes D. Assuming that the panel capacitance is 100 nF and the coil inductance is 100 nH, the peaks are reached in about 300 ns. The CU2/CU3 of the X-side driving circuit 101 and the CD2/CD3 of the Y-side driving circuit 103 are turned on at the timing at which the peaks are almost reached, thereby maintaining the Xod electrodes at Vs and the Yod electrodes at 0 V. Similarly, an electric current flows from the LC resonant power source (Vs/2) to the Yev electrodes (0 V) of the panel capacitances C through the LU1 of the Y-side driving circuit 103 and the Yev inductor L. At the same time, an electric current flows from the Xev electrodes (0 V) of the panel capacitances C to the LC resonant power source (Vs/2) through the Xev inductor L and the LD2 of the X-side driving circuit 101. Consequently, the voltages of the Xev/Yev are substantially reversed by resonance (ω=½π√LC), and they are held at the peak voltages by the diodes D. Then, the CU1/CU4 of the Y-side driving circuit 103 and the CD1/CD4 of the X-side driving circuit 101 are turned on at the timing at which the peaks are almost reached, and the Yev electrodes and the Xev electrodes are maintained at Vs and 0 V respectively. In a similar manner, after about 5 μs passes, the potentials of the Xod/Xev/Yod/Yev are reversed by LC resonance, and the voltages are clamped about 300 ns later. After the write of wall charges by addressing, a sustain voltage pulse is alternately applied in this manner to generate sustain discharge only in the addressed discharge cells 111, for display.

The voltage rise of the Xod and the voltage drop of the Xev are synchronized and the LC resonant cycle/electric currents are equal, so that magnetic fields generated in the LC resonant circuit are cancelled out, resulting in reduction in equivalent wiring inductance. Further, electric currents flowing to and from the LC resonant power source Vc are equal, so that, even with large impedance from an external power source, no voltage fluctuation occurs in the power source Vc of the X-side driving circuit 101. Further, LC resonant currents similarly flow in reverse directions at the voltage drop of the Yod and the voltage rise of the Yev, resulting in reduction in equivalent wiring inductance and elimination of voltage fluctuation of the power source Vc of the Y-side driving circuit 103. As a result, waveform distortion at the X/Y voltage rise/drop is eliminated to enable a high-speed operation and reduction in power loss in charging/discharging the capacitances.

When the voltage Vs is applied between the electrodes of the discharge cells, sustain discharge occurs in the addressed discharge cells and a pulsed electric current proportional to the number of the discharge cells flows. If the number of the discharge cells is substantially the same, the discharge currents are also substantially equal. Therefore, since the gas discharge current between the Xod-Yod and an electric current between the Xev-Yev are reverse in direction and substantially equal in size, equivalent inductance of elements and wiring is small and fluctuation in potential difference of power sources of the X/Y driving circuits is small. As a result, even the flow of a pulsed, large gas discharge current causes only small deterioration/fluctuation in voltage applied to the display cells, so that deterioration in luminance/light-emission efficiency and unstable discharge are improved.

In this embodiment, the voltage rise of the even electrodes Yev among the electrodes Y on one side is synchronized with the voltage rise of the odd electrodes Xod among the display electrodes X on the opposite side. Further, the voltage drop of the even lines Xev of the display electrodes X and the odd lines Yod of the display electrodes Y are synchronized with the voltage rise of the Xod.

In short, the waveform timing of the Xod is the same as that of the Yev, and the waveforms for the Xev/Yod and those for the Xod/Yev are in opposite phases. The voltage rise/drop by LC resonance and the voltage clamp at high voltage/low voltage are performed in the same manner as in the first embodiment. Consequently, at the timing of the voltage rise of the Xod, LC resonant currents flow as follows. In the odd lines, the LC resonant current flows from the LC resonant power supply capacitor on the X side to the Xod electrodes of the panel capacitances C through the Xod capacitance charge-side FET and the Xod inductor L, and the LC resonant current flows from the Yod electrodes of the panel capacitances C to the LC resonant power supply capacitor on the Y side through the Yod inductor L and the Yod capacitance charge-side FET. In the even lines, the LC resonant current flows from the LC resonant power supply capacitor on the Y side to the Yev electrodes of the panel capacitances C through the Yev capacitance charge-side FET and the Yev inductor L, and the LC resonant current flows from the Xev electrodes of the panel capacitances C to the LC resonant power supply capacitor on the X side through the Xev inductor L and the Xev capacitance discharge-side FET.

In the AC-type memory driving, the discharge currents flow in the display cells. In the odd lines, it flows from the X-side VH power source to the Y-side VL power source through the Xod high-voltage clamp FET and the Yod low-voltage clamp FET, and in the even lines, it flows from the Y-side VH power source to the X-side VL power source through the Yev high-voltage clamp FET and the Xev low-voltage clamp FET.

At the voltage drop timing of the Xod electrodes, the LC resonant current/discharge current both flow in a direction from the Yod to the Xod and in a direction from the Xev to the Yev.

If the circuit constant is the same, the LC resonant frequencies and electric currents in the odd lines/even lines are equal, and the electric currents flow between the X-side LC resonant power source and the Y-side LC resonant power source. As a result, electric currents equal in size flow to/from the X and Y LC resonant power sources, resulting in no fluctuation in LC resonant power source. Wiring lines of the driving circuits/panel are divided into the even lines/odd lines which are parallel to one another, and the directions of electric currents flowing therethrough are reverse to each other. This reduces wiring impedance, enabling LC resonance as designed.

If the odd and even lines have substantially the same number of the discharge cells, discharge currents are also equal, also resulting in reduced voltage fluctuation between the low-voltage/high-voltage power sources and reduction in equivalent wiring impedance of the driving circuits/panel. Consequently, with even a large discharge current, the discharge sustain voltage pulse suffers only a small voltage fluctuation/waveform distortion.

The use of the panel/driving circuits/driving waveforms of this embodiment makes it possible to apply a high-speed voltage pulse free of distortion, owing to the effects of reducing fluctuation in power source voltage and lowering wiring inductance related to the LC resonance and the discharge current.

This embodiment is also applicable to a so-called ALIS method. Specifically, in the first frame, sustain discharge is caused in the display cells between the Xod and the Yod electrodes and in the display cells between the Xev and Yev electrodes. In the second frame, sustain discharge is caused in the display cells between the Xev and Yod electrodes and in the display cells between the Xod and Yev electrodes.

### Fourth Embodiment

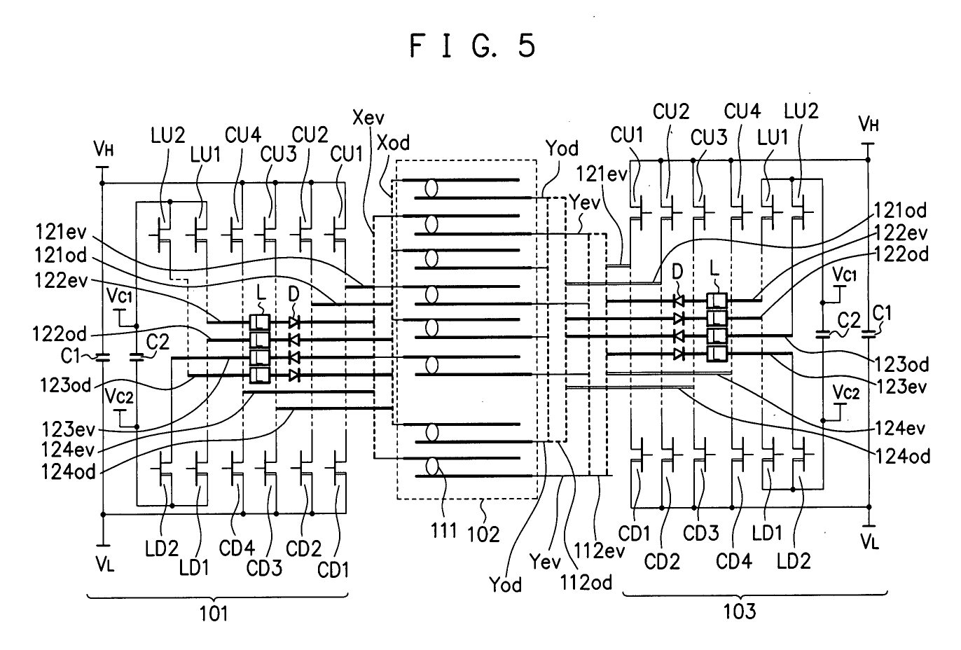

FIG. 5 is a circuit diagram showing a configuration example of a plasma display device according to a fourth embodiment of the present invention. What are different in the circuit in FIG. 5 from the circuit in FIG. 1 will be described. FETs of an LU1 and an LU2 are connected to a power supply voltage Vc1, and FETs of an LD1 and an LD2 are connected to a power supply voltage Vc2. A capacitor C2 is connected between the power supply voltages Vc1 and Vc2. The power supply voltage Vc1 is Vc+α and thus is a voltage higher than the voltage Vc. The power supply voltage Vc2 is Vc−α and thus is a voltage lower than the voltage Vc.

LC resonant power source portions of this embodiment are different from those in FIG. 1. The LC power supply voltage on a charge side is Vc+α that is higher than the intermediate potential Vc of a sustain voltage pulse, and that on a discharge side is Vc−α that is lower than Vc. A large capacitor C2 is mounted therebetween. The power source Vc−α does not consume power since it recovers electric charges accumulated in panel capacitances C at a high voltage VH, and is utilized as a power source of the power source Vc+α.

It is assumed that VH=Vs, VL=0 V, and Vc=Vs/2, and a resonant peak voltage at the voltage rise from 0 V to Vs by LC resonance in the circuit in FIG. 1 is assumed to be η Vs. Here, the description will be given on assumption that Vs=180 V and η−0.9.

In a case where the panel capacitances C are charged by the LC resonant circuit in the circuit in FIG. 1, due to the influence of the resistance of the FETs and diodes and due to stray capacitance/wiring inductance, the voltage Vs reached at the rise is slightly lower than 180 V, and the voltage reached at the drop is slightly higher than 0 V. For example, they are 162 V and 18 V respectively. When, in driving the electrodes, the LC resonant power supply voltage (Vc+α) on the charge side is set to 100 V and the LC resonant voltage on the discharge side is set to (Vc−α), reached LC resonant voltages of LC resonance are substantially Vs (η×2×100=180 V) and 0 V (180−η×2×(180−80)=0V). According to this embodiment, the voltages reach Vs or 0 V by LC resonance, and there is no sharp voltage rise/drop by a voltage clamp circuit from 162 V to 180 V and from 18 V to 0 V. This reduces electromagnetic-wave radiation noise/conduction noise. The LC resonant voltage (Vc−α) on the discharge side stems only from the electric charges accumulated in the panel, and the recovered power is used for charging the panel, and thus the voltage of (Vc+α) is generated by utilizing the voltage of (Vc−α).

If the LC resonant voltages on the charge side and on the discharge side are further greatly changed in this circuit, it becomes possible to make the high-voltage side higher than Vs and to make the low-voltage side lower than 0 V with stable voltage waveforms at an initial stage of the sustain voltage pulse. When the voltage that is reached at the rise of the sustain discharge pulse is set higher, discharge at a lower Vs voltage becomes possible. For example, when the LC resonant voltage (Vc+α) on the charge side is set to 110 V and the resonant peak voltage is set to 198 V, sustain discharge at Vs=175 V (the high-voltage clamp voltage is 175 V) is enabled. At this time, the LC resonant voltage (Vc−α) on the discharge side is 65 V, and the minimum resonant voltage is −23 V. In this embodiment, applying a high voltage at the initial stage of the sustain discharge pulse causes sustain discharge at a voltage that is about 5 V lower than a typical sustain voltage. This reduces discharge intensity, improves light-emission efficiency, and reduces resistance loss. In the circuit in FIG. 5, waveform distortion is small and power consumption is small, enabling application of a high-speed pulse.

In this embodiment, ideal power recovery by the LC resonant circuit will result in no power loss in charging/discharging the panel capacitances and no power consumption. In the first embodiment, the influences of the wiring inductance of the driving circuits/panel are alleviated, but resistance loss and the like occur in the wiring and driving FET elements, resulting in low ultimate voltage.

For example, when the voltage is raised from 0 V to Vs by LC resonance, it is assumed that the LC resonant power supply voltage is Vs/2 and the LC resonant voltage in the driving circuits/panel reaches η×Vs (η<1) due to the resistance loss of the circuit. At this time, the voltage is raised to Vs by charging by the high-voltage (Vs) clamp circuit, but the voltage is sharply raised from η×Vs to Vs, resulting in large electromagnetic-wave radiation.

Assuming that the LC resonant power supply voltage at the time of charging is η×Vs/2 and the LC resonant power supply voltage at the time of discharging is Vs−η×Vs/2, the LC resonant voltages reach substantially Vs and 0 V, and thus no sharp voltage rise occurs, resulting in reduction in electromagnetic-wave radiation.

Setting the LC resonant power supply voltage further higher or lower can cause overshoot of the voltage pulse waveform. When the voltage that is reached at the rise of the discharge sustain voltage is set higher, discharge is sustained even at a Vs voltage that is lower than the typical discharge sustain voltage, resulting in reduced discharge intensity. Lowering intensity of single discharge can realize reduction in resistance loss and improvement in light-emission efficiency.

### Fifth Embodiment

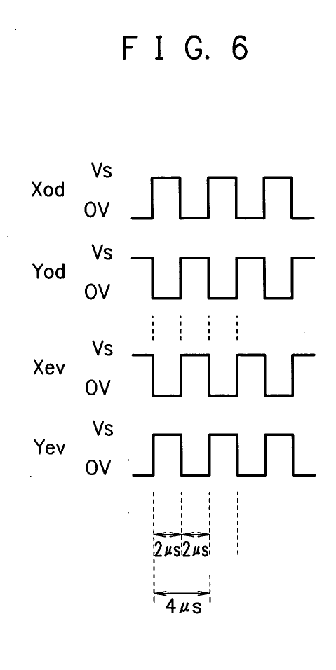

FIG. 6 is a waveform chart showing waveforms of sustain discharge voltages according to a fifth embodiment of the present invention. The waveforms in this embodiment are substantially the same as those in FIG. 4, but the voltage is kept for 2 μs instead of 5 μs and the sustain discharge cycle is 2 μs instead of 5 μs. FIG. 6 shows only the driving waveforms after the discharge is stabilized. However, for the initial sustain discharge after addressing, a wide voltage pulse as in FIG. 3 is applied, and after the discharge is stabilized, the waveforms shift to the driving waveforms in FIG. 6. Further, the driving waveforms in FIG. 4 and the driving waveforms in FIG. 6 are different in discharge sustain voltage and also in sustain discharge. For example, Vs=160 V in the waveforms in FIG. 6 while Vs=180 in the waveforms in FIG. 4.

The following description will be on a case where the driving waveforms in FIG. 6 are applied for display. Shortening the discharge cycle up to about 2 μs makes it possible to generate sustain discharge at a low voltage owing to the priming effect of residual ions/electrons in a discharge space, resulting in improved light-emission efficiency. In actual driving, typical resetting, addressing, and sustain discharge are performed, and after the discharge is stabilized, the width of the discharge sustain pulse is narrowed and the voltage is lowered, and then the driving shifts to so-called AC-type high-speed pulse memory driving.

For example, immediately after the addressing, a pulse array with the driving waveforms in FIG. 4 is applied in which the sustain voltage pulse width is longer than 2 μs, namely, 5 μs (sustain discharge cycle 5 μs) and a sustain voltage Vs is 180 V, and two cycles of sustain discharge is performed four times to stabilize sustain discharge/wall charges. Thereafter, the sustain voltage pulse at the voltage Vs=180 V (pulse width 2 μs) is applied with the driving waveforms in FIG. 4, and thereafter, the sustain voltage array with Vs=160 V and the pulse width of 2 μs is applied as shown in FIG. 6. The driving waveforms in FIG. 4 have a small priming effect because the discharge cycle is 5 μs, and 180 V is required for the sustain voltage of the initial wide sustain pulse. Since the next narrow sustain pulse causes discharge within 2 μs from the previous sustain discharge, sustain discharge at a lower sustain voltage Vs=160 V is enabled owing to the priming effect. The narrow width of the sustain voltage pulse and low voltage contribute to the reduction in the intensity of single discharge. Consequently, efficiency deterioration caused by ultraviolet radiation/absorption and by phosphor excitation saturation is suppressed. Further, owing to the low voltage, circuit loss is reduced, if the frequency is the same. Changing the voltage pulse width and voltage by two stages or more or changing them slowly and continuously enables smooth shift to the AC-type high-speed pulse memory discharge to ensure stable display.

In this embodiment, if the time interval between the end and start of the discharge (the sustain discharge cycle) is set to 2 μs or shorter, many ions and electrons remain in the discharge space. This makes it possible to generate the sustain discharge at a low applied voltage, so that improved light-emission efficiency is realized. On the other hand, in conventional driving circuits/panel, wiring inductance makes it difficult to apply a high-speed, high-voltage pulse and power consumption is large. In addition, due to the narrow pulse width, stable discharge sustain was not possible if the voltage drops in the gas discharge.

According to the devices in FIG. 1 and FIG. 5, it is possible to apply the high-speed sustain voltage pulse and to generate stable sustain discharge, with the time interval between the end and start of the discharge being 2 μs or shorter. Reducing the discharge interval to 2 μs or shorter enables sustain discharge with small intensity of single discharge, resulting in improved light-emission efficiency. According to this embodiment, it is possible to apply a high-speed pulse with small waveform distortion and to reduce power consumption of the circuit, and to realize high-luminance display by the high-speed AC memory driving utilizing space charges.

As has been described hitherto, in the first to fifth embodiments, the driving circuit for the discharge sustain pulse is composed of: the circuit for rising/dropping the voltage by LC resonance of the panel capacitances and the series inductor LC; and the high-voltage/low-voltage clamp circuit for preventing the voltage from fluctuating even when the gas discharge current flows. At the time of the LC resonance, wiring inductance gives no influence and the fluctuation in resonant power source is eliminated, thereby enhancing power recovery efficiency. At the time of the gas discharge, the pulsed discharge current flows, so that impedance of the clamp circuit, especially, inductance is reduced, and by preventing voltage fluctuation of the clamp power source, problems such as waveform distortion, power loss, and electromagnetic-wave noise can be solved.

As for the inductance of the driving circuits/panel, the wiring lines are divided into the plural pairs and they are arranged alternately in parallel so that electric currents equal in size flow concurrently in reverse directions, which makes it possible to greatly reduce equivalent inductance compared with a case where a single wiring line is arranged and an electric current flows in one direction. Further, since the display electrodes in the panel are arranged in parallel, equivalent inductance is reduced if the driving waveforms are designed so that electric currents in the odd and even lines flow concurrently in reverse directions. The inductance of the driving circuits is also greatly reduced by a specially devised design of component arrangement/printed board wiring and so on and by designing the driving waveforms so that electric currents equal in size concurrently flow in reverse directions through parallel wiring lines.

The circuit and driving waveforms are designed so that resonant currents equal in size flow concurrently to/from the circuit board on the same terminal side of the panel, so that the LC resonant power source-side voltage is prevented from fluctuating. As for the clamp power source, the circuit and the driving waveforms are designed so that on the same circuit board, electric currents equal in size flow concurrently from the high-voltage power source and to the low-voltage power source, and a large capacitor is disposed between the high-voltage power source and the low-voltage power source with low impedance, thereby preventing fluctuation in potential difference between the high voltage and the low voltage.

As has been described hitherto, the present invention features small distortion of the sustain discharge pulse and small power loss. Even if the number of the display cells is large, no deterioration in luminance and light-emission efficiency is caused, realizing stable display. In addition, changing the LC resonant power supply voltage causes the sustain pulse to smoothly rise to the sustain voltage, so that radiation noise is small, and in low-voltage discharge where the initial voltage of the sustain discharge pulse is raised, light-emission efficiency can be improved. Further, it is possible to apply a high-frequency pulse free of distortion, and low-voltage discharge utilizing residual space charges makes it possible to lower the intensity of single discharge, so that light-emission efficiency is improved.

In the adjacent current paths, electric currents concurrently flow in reverse directions to each other, so that electromagnetic waves can be cancelled out by each other to reduce equivalent wiring inductance. This makes it possible to reduce waveform distortion of the voltages applied to the X electrodes and the Y electrodes, reduce power loss, improve light-emission efficiency, and reduce electromagnetic-wave noise.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

1. A display device comprising:
a plurality of X electrodes consisting of odd-numbered electrodes and even-numbered electrodes;
a plurality of Y electrodes consisting of odd-numbered electrodes and even-numbered electrodes, with capacitances being formed between said plural X electrodes and said plural Y electrodes;
a first X-electrode current path through which an electric current flows to/from the odd-numbered X electrodes;
a second X-electrode current path which is adjacent on a same substrate to said first X electrode-current path and through which an electric current flows from/to said even-numbered X electrodes in synchronization with and in a reverse direction to the flow of the electric current to/from said odd-numbered X electrodes through said first X-electrode current path;
a first Y-electrode current path through which an electric current flows to/from said odd-numbered Y electrodes; and
a second Y-electrode current path which is adjacent on a same substrate to said odd-numbered Y electrodes and through which an electric current flows from/to said even-numbered Y electrodes in synchronization with and in a reverse direction to/from the flow of the electric current to said odd-numbered Y electrodes through said first Y-electrode current path.

2. The display device according to claim 1,
wherein diodes in reverse directions to each other are connected to said first and second X-electrode current paths respectively, and diodes in reverse directions to each other are connected to said first and second Y-electrode current paths respectively.

3. The display device according to claim 2,
wherein inductors are connected to said first and second X-electrode current paths respectively, and inductors are connected to said first and second Y-electrode current paths respectively.

4. The display device according to claim 3,
wherein the diode of said first X-electrode current path is connected in a direction so as cause the electric current to flow to said odd-numbered electrodes,
wherein the diode of said second X-electrode current path is connected in a direction so as to cause the electric current to flow from said even-numbered X electrodes,
wherein the diode of said first Y-electrode current path is connected in a direction so as to cause the electric current to flow to said odd-numbered Y electrodes, and
wherein the diode of said second Y-electrode current path is connected in a direction so as to cause the electric current to flow from said even-numbered Y electrodes, and
the display device further comprising:
a third X-electrode current path to which a diode and an inductor are connected and through which an electric current flows from said odd-numbered X electrodes;
a fourth X-electrode current path which is adjacent on a same substrate to said third X-electrode current path, to which a diode and an inductor are connected, and through which an electric current flows to said even-numbered X electrodes in synchronization with and in a reverse direction to the flow of the electric current from said odd-numbered X electrodes through said third X-electrode current path;
a third Y-electrode current path to which a diode and an inductor are connected and through which an electric current flows from said odd-numbered Y electrodes; and
a fourth Y-electrode current path which is adjacent on a same substrate to said third Y-electrode current path, to which a diode and an inductor are connected, and through which an electric current flows to said even-numbered Y electrodes in synchronization with and in a reverse direction to the flow of the electric current from said odd-numbered Y electrodes through said third Y-electrode current path.

5. The display device according to claim 4, further comprising:
a fifth X-electrode current path capable of supplying one of a high potential and a low potential to said odd-numbered X electrodes;
a sixth X-electrode current path which is adjacent on a same substrate to said fifth X-electrode current path and which is capable of supplying one of the low potential and the high potential to said even-numbered X electrodes so as to cause an electric current to flow therethrough in synchronization with and in a reverse direction to a flow of an electric current through said fifth X-electrode current path;
a fifth Y-electrode current path capable of supplying one of the high potential and the low potential to said odd-numbered Y electrodes; and
a sixth Y-electrode current path which is adjacent on a same substrate to said fifth Y-electrode current path and which is capable of supplying one of the low potential and the high potential to said even-numbered Y electrodes so as to cause an electric current to flow therethrough in synchronization with and in a reverse direction to a flow of an electric current through said fifth Y-electrode current path.

6. The display device according to claim 5,
wherein an intermediate potential between the high potential and the low potential is applicable to said first to fourth X-electrode current paths, and the intermediate potential between the high potential and the low potential is applicable to said first to fourth Y-electrode current paths.

7. The display device according to claim 5, further comprising:
a seventh X-electrode current path capable of supplying one of the high potential and the low potential to said odd-numbered X electrodes;
an eighth X-electrode current path which is adjacent on a same substrate to said seventh X-electrode current path and which is capable of supplying one of the low potential and the high potential to said even-numbered X electrodes so as to cause an electric current to flow therethrough in synchronization with and in a reverse direction to a flow of an electric current through said seventh X-electrode current path;
a seventh Y-electrode current path capable of supplying one of the high potential and the low potential to said odd-numbered Y electrodes; and
an eighth Y-electrode current path which is adjacent on a same substrate to said seventh Y-electrode current path and which is capable of supplying one of the low potential and the high potential to said even-numbered Y electrodes so as to cause an electric current to flow therethrough in synchronization with and in a reverse direction to a flow of an electric current through said seventh Y-electrode current path.

8. The display device according to claim 7,
wherein an intermediate potential between the high potential and the low potential is applicable to said first to fourth X-electrode current paths, and the intermediate potential between the high potential and the low potential is applicable to said first to fourth Y-electrode current paths.

9. The display device according to claim 1,
wherein said first X-electrode current path is capable of supplying one of a high potential and a low potential to said odd-numbered X electrodes,
wherein said second X-electrode current path is capable of supplying one of the low potential and the high potential to said even-numbered X electrodes so as to cause the electric current to flow therethrough in synchronization with and in the reverse direction to the flow of the electric current through said first X-electrode current path,
wherein said first Y-electrode current path is capable of supplying one of the high potential and the low potential to said odd-numbered Y electrodes, and
wherein said second Y-electrode current path is capable of supplying one of the low potential and the high potential to said even-numbered Y electrodes so as to cause the electric current to flow therethrough in synchronization with and in the reverse direction to the flow of the electric current through said first Y-electrode current path.

10. The display device according to claim 6, wherein the intermediate potential between the high potential and the low potential is applicable to said first to fourth X-electrode current paths, and the intermediate potential between the high potential and the low potential is applicable to said first to fourth Y-electrode current paths.

11. The display device according to claim 6,
wherein a potential that is higher than the intermediate potential between the high potential and the low potential is applicable to said first and fourth X-electrode current paths, and a potential that is lower than the intermediate potential between the high potential and the low potential is applicable to said second and third X-electrode current paths, and
wherein the potential that is higher than the intermediate potential between the high potential and the low potential is applicable to said first and fourth Y-electrode current paths, and the potential that is lower than the intermediate potential between the high potential and the low potential is applicable to said second and third Y-electrode current paths.

12. The display device according to claim 1,
wherein a sustain discharge voltage is applied to cause display discharge between said X electrodes and said Y electrodes, in such a manner that a rise timing and a drop timing of a voltage of said odd-numbered X electrodes are synchronized with a rise timing and a drop timing of a voltage of said even-numbered Y electrodes, a voltage of said even-numbered X electrodes and the voltage of said odd-numbered X electrodes have opposite phases, and a voltage of said odd-numbered Y electrodes and the voltage of said even-numbered Y electrodes have opposite phases.

13. The display device according to claim 1,
wherein voltages for causing display discharge between said X electrodes and said Y electrodes are applied to said X electrodes and said Y electrodes so as to cause the display discharge to occur at a cycle of 2 μs or shorter.

14. The display device according to claim 13,
wherein the voltages for causing the display discharge between said X electrodes and said Y electrodes are first applied to said X electrodes and said Y electrodes so as to cause the display discharge to occur at a longer cycle than 2 μs, and subsequently, the voltages are applied to said X electrodes and said Y electrodes so as to cause the display discharge to occur at the cycle of 2 μs or shorter.

15. The display device according to claim 14,
wherein a voltage between said X electrodes and said Y electrodes when the display discharge occurs at the cycle of 2 μs or shorter is lower than a voltage between said X electrodes and said Y electrodes when the display discharge occurs at the longer cycle than 2 μs.

16. The display device according to claim 6, wherein a sustain discharge voltage is applied to cause display discharge between said X electrodes and said Y electrodes, in such a manner that a rise timing and a drop timing of a voltage of said X electrodes are synchronized with a rise timing and a drop timing of a voltage of said Y electrodes, a voltage of said even-numbered X electrodes and the voltage of said odd-numbered X electrodes have opposite phases, and a voltage of said odd-numbered Y electrodes and the voltage of said even-numbered Y electrodes have opposite phases.

17. The display device according to claim 6,
wherein voltages for causing display discharge between said X electrodes said Y electrodes are applied to said X electrodes and said Y electrodes so as to cause the display discharge to occur at a cycle of 2 μs or shorter.

18. The display device according to claim 17,
wherein the voltages for causing the display discharge between said X electrodes and said Y electrodes are first applied to said X electrodes and said Y electrodes so as to cause the display discharge to occur at a longer cycle than 2 μs, and subsequently, the voltages are applied to said X electrodes and said Y electrodes so as to cause the display discharge to occur at the cycle of 2 μs or shorter.

19. The display device according to claim 18,
wherein a voltage between said X electrodes and said Y electrodes when the display discharge occurs at the cycle of 2 μs or shorter is lower than a voltage between said X electrodes and said Y electrodes when the display discharge occurs at the longer cycle than 2 μs.

20. The display device according to claim 6,
wherein the low potential is 0 V (zero volt).
